(19) United States
(12) Patent Application Publication
(10) Pub. No.: US 2015/0332280 A1
(43) Pub. Date: Nov. 19, 2015

(54) COMPLIANT AUDITING ARCHITECTURE

(71) Applicant: Microsoft Technology Licensing, LLC, Redmond, WA (US)

(72) Inventors: Ketaki Arun Deshpande, Redmond, WA (US); Gaurav Batra, Bellevue, WA (US); Arman Centeno Reyes, Seattle, WA (US); Serguei V. Martchenko, Redmond, WA (US); Sara Louise Manning Dawson, Bellevue, WA (US)

(21) Appl. No.: 14/548,147

(22) Filed: Nov. 19, 2014

Related U.S. Application Data
(60) Provisional application No. 61/994,780, filed on May 16, 2014.

(51) Int. Cl. G06Q 30/00

(52) U.S. Cl. CPC G06Q 30/018

(57) ABSTRACT

A compliant auditing architecture is implemented such that a uniform experience of collecting, storing, and interacting with audit data may be provided for various compliance scenarios. A user action to be audited may be detected through a user interface of an auditing application, and a protocol service of the application may generate an audit event corresponding to the user action. The protocol service may transmit audit data associated with the audit event to a local queue of a datacenter for short-term storage, and an upload service hosted by the datacenter may upload the audit data from the local queue, and transmit the audit data to a data store for long-term storage. In response to a request from an administrator, the stored audit data may be converted to a format compatible with one or more compliance interfaces, and transmitted to the administrator through the interfaces for querying and/or reporting.

### CROSS-REFERENCE TO RELATED APPLICATIONS

This application claims priority to U.S. Provisional Application Ser. No. 61/994,780 filed on May 16, 2014. The Provisional Application is herein incorporated by reference in its entirety.

### BACKGROUND

Audit of user activities for the purpose of compliance with industry laws and regulations is a top feature requested by customers who are working in regulated industries such as financial, legal, insurance, and/or health care. However, some existing auditing features may be insufficient, failing to meet customer requirements. One such feature may include limited retention of audit data. For example, in some of the industries the regulations demand the retention of audit data for up to 7 years, and the default retention of the audit data is only 90 days. Additional features may include an insufficient user interface for reporting audit data, and an inconvenient format of the audit data for export. Furthermore, existing implementations of auditing architecture have several limitations which affect customer experience with the audit data.

Accordingly, current implementations of auditing architecture could use improvements and/or alternative or additional solutions such that a uniform experience of collecting, storing, and interacting with audit data may be provided for various compliance scenarios.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to collection and storage of audit data implementing a compliant auditing architecture. An example method may include detecting a user action through a user interface of an application executed on a client device associated with a user; generating an audit event corresponding to the user action though a protocol service; and transmitting audit data associated with the audit event from the protocol service to a local queue of a datacenter for short-term storage, where the audit data is uploaded from the local queue through an upload service hosted by the datacenter for long-term storage at a data store.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 includes a conceptual diagram illustrating an example datacenter-based system where a compliant auditing architecture may be implemented;

FIG. 2 illustrates a conceptual system, where a compliant auditing architecture may be implemented;

FIG. 3 illustrates an example process for collecting, storing, and enabling user interaction with audit data implementing a compliant auditing architecture;

FIG. 4 illustrates an example uploading process within a compliant auditing architecture;

FIG. 5 illustrates an example storage process within a compliant auditing architecture;

FIG. 6 is a block diagram of an example general purpose computing device, which may be used to collect and store audit data implementing a compliant auditing architecture; and

FIG. 7 illustrates a logic flow diagram of a method to collect and store audit data implementing a compliant auditing architecture, according to embodiments.

### DETAILED DESCRIPTION

As briefly described above, a compliant auditing architecture may be implemented such that a uniform experience of collecting, storing, and interacting with audit data may be provided for various compliance scenarios. A user action may be detected through a user interface of an auditing application executed on a client device associated with a user. The user action may be an action requiring auditing, such as a create, read, update, and/or delete action, a permission change, a forward, a share, a print, and/or a command execution, among other examples. A protocol service of the auditing application may be configured to generate an audit event corresponding to the user action, and transmit audit data associated with the audit event to a local queue of a datacenter for short-term storage. An upload service hosted by one or more processing servers of the datacenter may upload the audit data from the local queue and transmit the uploaded audit data to a data store for long-term storage. In response to a request from an administrator, the stored audit data may be converted to a compatible format with one or more compliance interfaces including a query interface and an audit reporting interface, and transmitted to the administrator through the interfaces for querying and/or reporting statistical information associated with the audit data.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or, a compact disk, and comparable hardware media.

Throughout this specification, the term “platform” may be a combination of software and hardware components for implementing a compliant auditing architecture to collect, store, and enable user interaction with audit data. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

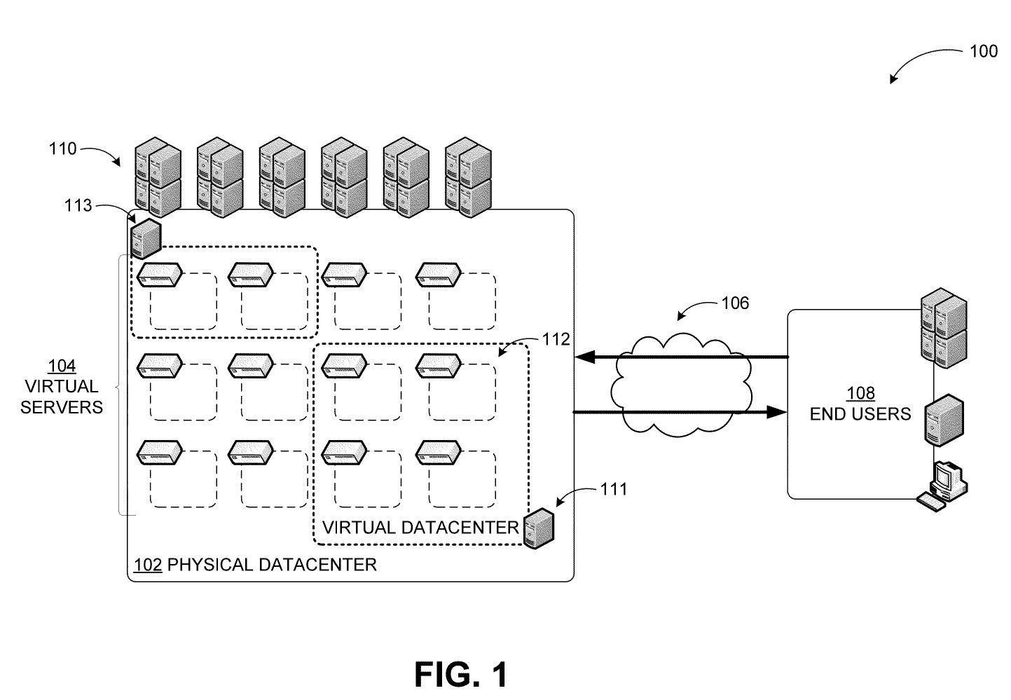

FIG. 1 includes a conceptual diagram illustrating an example datacenter-based system where a compliant auditing architecture may be implemented.

As shown in a diagram 100, a datacenter 102 may include one or more servers 110, 111, and 113 that are physical servers associated with software and underlying hardware of the datacenter 102. The one or more servers 110, 111, and 113 may be configured to execute one or more virtual servers 104. For example, the servers 111 and 113 may be configured to provide four virtual servers and two virtual servers, respectively. In some embodiments, one or more virtual servers may be combined into one or more virtual datacenters. For example, the four virtual servers provided by the servers 111 may be combined into a virtual datacenter 112. The virtual servers 104 and/or the virtual datacenter 112 may be configured to host a multitude of servers to provide cloud-related data/computing, services such as various applications, data storage, data processing, or comparable ones, to one or more end users 108, such as individual users or enterprise customers, via a cloud 106.

Existing implementations of auditing architecture may affect customer experience with the audit data. An example impact may be caused by audit data specific to workload scenarios being stored next to the workload itself. Due to historical reasons, there may be almost no overlap in the schema of the audit data collected for each workload making it difficult to maintain a common set of the scenarios supported for the auditing services, and to collect audit data for a new service, especially if the service does not have a dedicated long-term storage component. Another example impact may be caused by the coexistence of auditing scenarios with the other services specific to the workloads, where the auditing scenarios and other services share the resources and capacity allocated to that workload. Such architecture may be used when auditing features and scenarios are not broadly adopted, and the overall demand on the datacenter capacity for auditing purposes is low. However, this architecture may become a liability when customer demand for auditing features increases, and the audit-specific load grows. A further example impact may be caused by the highly fragmented nature of the audit data and that the data for a single tenant is usually distributed over hundreds of physical storage partitions. As a result, the performance of a query over audit data may vary greatly depending on how many partitions must be touched to complete the query.

In an example embodiment, the datacenter 102 may be hosting an auditing service that uploads/stores data, including audit data, from an auditing application executed on one or more client devices. Among other components, the datacenter 102 may include at least one short-term server comprising a local queue, at least one processing server hosting an upload service, at least one long-term storage server comprising a data store, and a communication module configured to transmit the audit data between the servers of the datacenter 102 and the one or more client devices. The at least one short-term server of the datacenter 102 may be configured to receive audit data associated with an audit event at the local queue from a protocol service of the auditing application, where the protocol service generated the audit event corresponding to a user action detected through a user interface of the auditing application. In some embodiments, data associated with multiple audit events generated from a variety of protocol services may accumulate at the local queue. The at least one processing server may be configured to upload the audit data and/or accumulated audit data through the upload service for long-term storage, and transmit the audit data to the at least one long-term storage server for storage at the data store.

In some embodiments, an administrator, such as a compliance officer, may request to receive the stored audit data. In response, the stored audit data may be converted to a format compatible with one or more compliance user interfaces of the auditing application, such as a query user interface and an audit reporting user interface. The audit data may then be transmitted through the user interfaces of the application executed on another client device associated with the administrator for querying the audit data and/or reporting statistical information associated with the audit data. In some examples, statistical information associated with the audit data from all tenants within the datacenter 102 may be reported for datacenter capacity planning and trend analysis.

In some embodiments, the audit data may be aggregated periodically to facilitate conversion of the stored audit data to a compatible format for the one or more compliance user interfaces in response to the request from the administrator to receive the stored audit data for the querying and/or reporting. In other embodiments, the audit data may be aggregated in response to detecting duplicated audit data, where the duplicated audit data is detected in response to detecting a match of the user action, the user, and an object of two audit events. The match of the user action, the user, and the object of two audit events may be detected at the protocol service of the auditing application, the local queue, the upload service, and the data store.

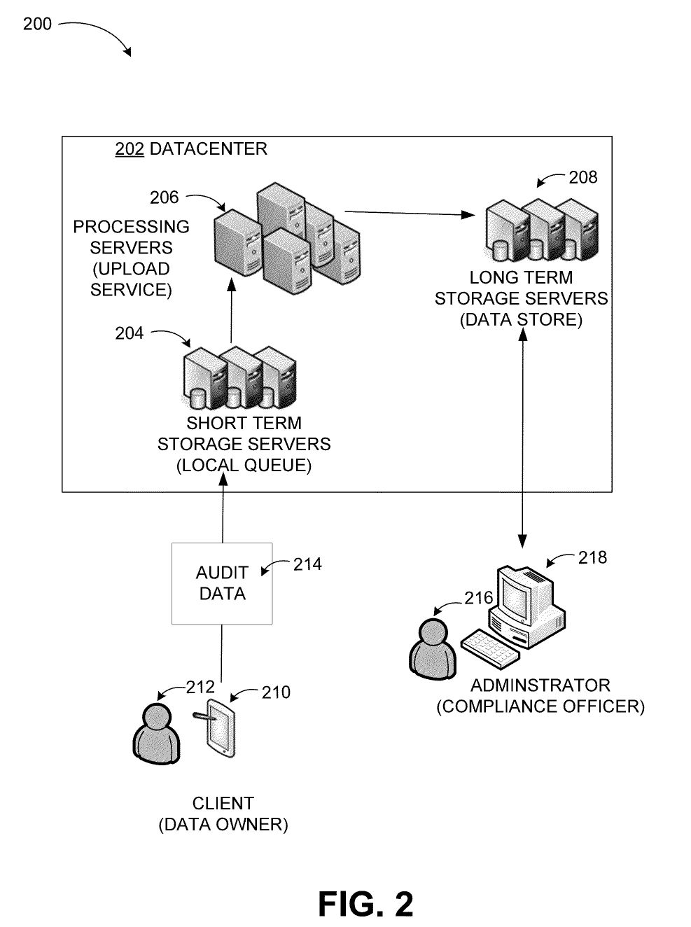

FIG. 2 illustrates a conceptual system, where a compliant auditing architecture may be implemented, according to some embodiments.

As illustrated in diagram 200, an example system may include a datacenter 202. The datacenter 202 may include, among other components, at least one short-term server 204 comprising a local queue, at least one processing server 206 hosting an upload service, and at least one long-term storage server 208 comprising a partitioned data store. The datacenter 202 may also include a communication module configured to transmit audit data 214 between the servers of the system and one or more client devices 210 associated with the system. In an example embodiment, the datacenter 202 may be hosting an auditing service that uploads/stores data, including the audit data 214, from an auditing application executed on the one or more client devices 210 associated with one or more users 212.

The at least one short-term server 204 of the datacenter 202 may be configured to receive the audit data 214 associated with an audit event at the local queue from a protocol service of the auditing application, where the protocol service generated the audit event corresponding to a user action detected through a user interface of the auditing application. The user action may be an action requiring auditing, such as a create, read, update, and/or delete action, a permission change, a forward, a share, a print, and/or a command execution, among other examples. In some embodiments, data associated with multiple audit events generated from a variety of protocol services may accumulate at the local queue. The at least one processing server 206 of the datacenter 202 may be configured to upload the audit data 214 through the upload service for long-term storage, and transmit the audit data 214 to the at least one long-term storage server 208 of the datacenter 202 for storage at the data store. In some examples, the upload service may be configured to batch the audit data during the upload such that the batched audit data is transmitted to corresponding partitions of the data store for long-term storage. In further examples, the upload service may verify a consistency and a correctness of the audit data 214 during the upload of the audit data.

The audit data 214 may be stored in two tables within the data store, a first table including query-searchable properties of the audit data 214 and a second table including overflow and multi-value properties of the audit data 214. In some embodiments, an administrator 216, such as a compliance officer, may request to retrieve the audit data 214 from the data store. In response, the audit data may be retrieved from the data store by the at least one long-term storage server 208, and converted to a format compatible with one or more compliance user interfaces of the auditing application, such as a query user interface and an audit reporting user interface. The audit data 214 may then be transmitted to the administrator 216 through the user interfaces of the application executed on another client device 218 associated with the administrator 216 for querying and/or reporting statistical information associated with the audit data.

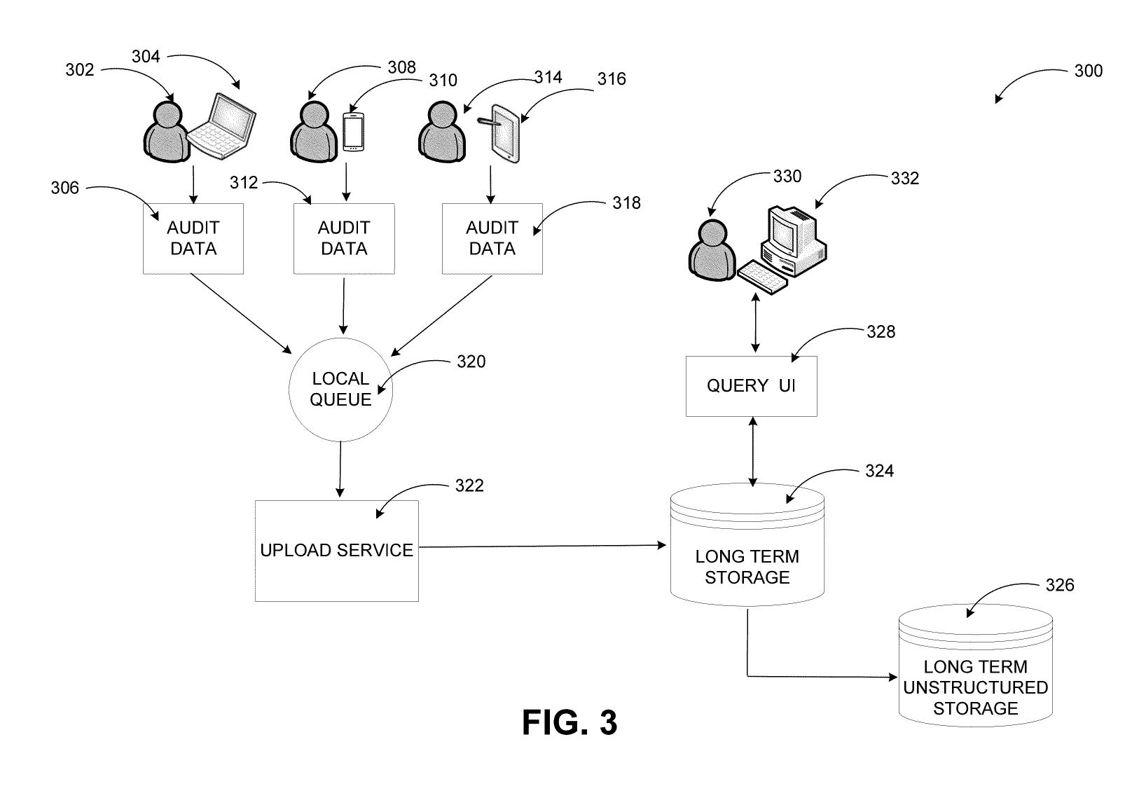

FIG. 3 illustrates an example process for collecting, storing, and enabling user interaction with audit data implementing a compliant auditing architecture.

As illustrated in FIG. 3, one or more users may perform a user action that requires auditing, where the user action is detected through a user interface of an auditing application executed on one or more client devices associated with the users. In an example scenario, a first user 302 may perform a permission change associated with mailbox security of the first user 302, where the permission change is detected through the user interface of the auditing application executed on a laptop 304 associated with the first user 302. A second user 308 may forward a sensitive document comprising personal health care information, where the forwarding is detected through the user interface of the auditing application executed on a smart phone 310 associated with the second user 308. A third user 314 may print a document with confidential financial information, where the printing is detected through the user interface of the auditing application executed on a tablet 316 associated with the third user 314. Other examples of user actions that may require auditing may include a create, read, update, and/or delete action, a share, and/or a command execution.

Protocol services of the auditing application executed on each of the client devices may be configured to generate audit events corresponding to each of the user actions, where the protocol services may be a same service or differing services for each. The protocol services may transmit audit data (e.g., 306, 312, and 318) associated with the audit events to a local queue 320 of a datacenter hosting an auditing service such that audit data associated with multiple audit events generated from a variety of protocol services may accumulate at the local queue 320. The accumulated audit data may be uploaded from the local queue through an upload service 322 hosted by the datacenter for transmission to long-term storage 324 at a data store, where the audit data may be batched during the upload such that the batched audit data is transmitted to corresponding partitions of the data store. The audit data may be stored in a structured manner within the data store. For examples, the audit data may be stored in two tables within the data store, a first table including query-searchable properties of the audit data and a second table including overflow and multi-value properties of the audit data 214. In some examples, the audit data stored in the long-term storage 324 may be transmitted to another long-term unstructured storage 326, where the audit data is no longer structured in a table manner as previously described. The audit data may be transmitted to the long-term unstructured storage 326 after a regulated period of time. For example, the audit data may be transmitted to the long-term unstructured storage 326 after all user interactions with the audit data, such as querying and reporting of statistical information associated with the audit data, have been completed.

In some embodiments, an administrator 330, such as a compliance officer, may request to retrieve the audit data from long-term storage 324 at the data store. In response, the audit data may be retrieved from the data store, and converted to a format compatible with one or more compliance user interfaces of the auditing application, such as a query user interface 328 and an audit reporting user interface. The audit data may then be provided to the administrator 330 through the query user interface 328 of the application executed on another client device, such as a desktop computer 332, associated with the administrator 330 for querying. In other examples, the audit data may be provided to the administrator 330 through the audit reporting user interface of the application executed on the desktop computer 332 for reporting statistical information associated with the audit data.

In some embodiments, the audit data may be aggregated periodically to facilitate the conversion of the stored audit data to the compatible format for the compliance user interfaces. In other embodiments, the audit data may be aggregated in response to detecting duplicated audit data, where the duplicated audit data is detected in response to detecting a match of the user action, the user, and an object of two audit events. The match of the user action, the user, and the object of two audit events may be detected at the protocol service of the auditing application, the local queue 320, the upload service 322, and the data store.

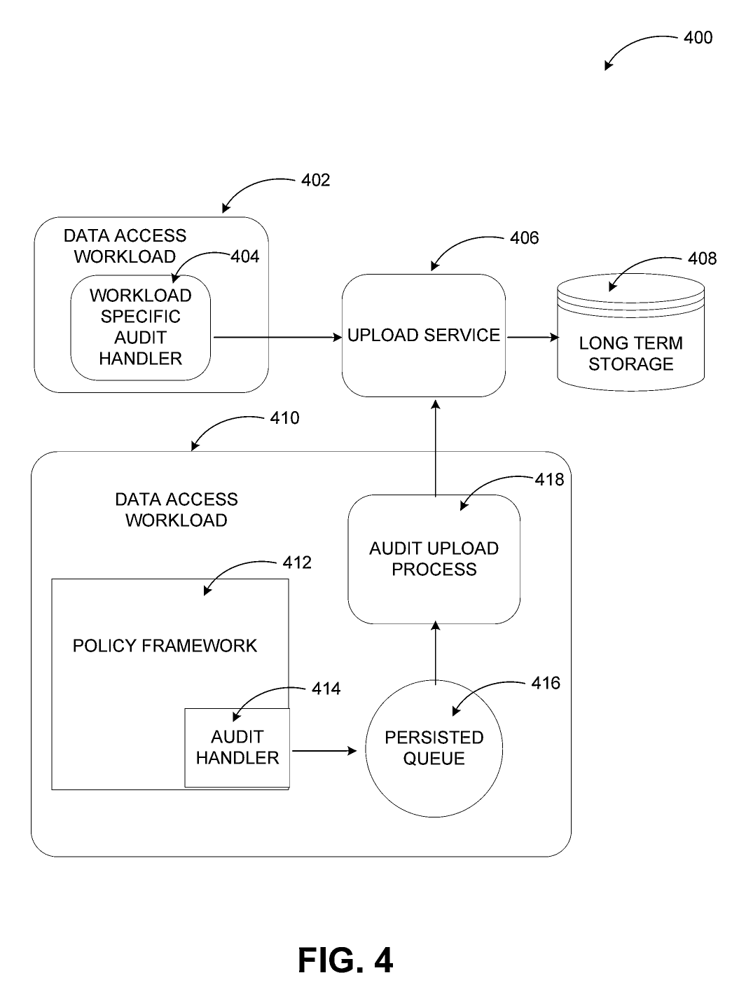

FIG. 4 illustrates an example uploading process within a compliant auditing architecture. An example uploading process may occur at a datacenter hosting an auditing service that uploads/stores data, including audit data, from an auditing application executed on a client device associated with a user.

A protocol service of the auditing application may be configured to generate an audit event corresponding to a user action detected through a user interface of the auditing application, and transmit audit data associated with the audit event to a local queue of the datacenter for short-term storage and accumulation. The audit may then be uploaded through an upload service 406 hosted by at least one processing server of the datacenter and transmitted to a data store for long-term storage 408.

In some embodiments, the upload of the audit data through the upload service 406 may be based on a specific workload of the protocol service of the auditing application. In one example, a data access workload 402 of the protocol service may not be integrated with a unified policy framework. Accordingly, the audit data may be transmitted directly from the protocol service of the application, by a workload specific audit handler 404, to the at least one processing server of the datacenter for uploading through the upload service 406, and transmission to the data store for long-term storage 408. In another example, a data access workload 410 of the protocol service may be integrated with a unified policy framework 412. In contrast to the previous example, the audit data may first be written into a persisted queue 416 of the protocol service by an audit handler 414 of the unified policy framework 412. The audit data may then be uploaded 418 from the persisted queue 416 by the protocol service prior to being transmitted from the protocol service of the application to the at least one processing server of the datacenter for uploading through the upload service 406.

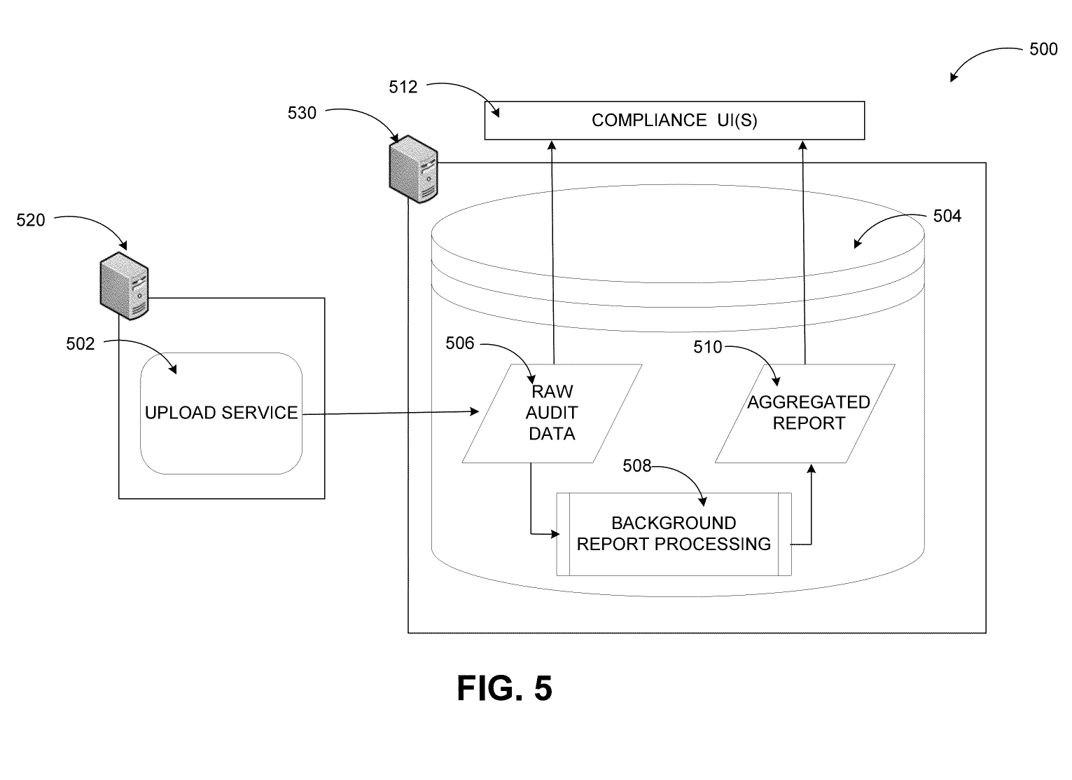

FIG. 5 illustrates an example storage process within a compliant auditing architecture. An example storage process may occur at a datacenter hosting an auditing service that uploads/stores data, including audit data, from an auditing application executed on a client device associated with a user.

A protocol service of the auditing application may be configured to generate an audit event corresponding to a user action detected through a user interface of the auditing application, and transmit audit data associated with the audit event to a local queue of the datacenter for short-term storage and accumulation. The audit data may then be uploaded through an upload service 502 hosted by at least one processing server 520 of the datacenter, and transmitted to a long-term storage server 530 of the datacenter comprising a data store 504 for long-term storage. Unlike the workload specific uploading process, the long-term storage of the audit data may be common to workloads of a variety of protocol services of the application

The audit data transmitted to the data store 504 may be raw audit data 506. In some examples, the raw audit data 506 may be stored in two tables within the data store 504, a first table including query-searchable properties of the audit data and a second table including overflow and multi-value properties of the audit data. In some embodiments, an administrator, such as a compliance officer, may request to retrieve audit data from the data store 504 for querying. Accordingly, the raw audit data 506 may be converted into a format compatible with a compliance user interface 512, such as a query user interface, of the auditing application, which may be executed on another client device associated with the administrator. In other embodiments, the administrator may request to retrieve audit data from the data store 504 for reporting. Accordingly, the raw audit data 506 may be processed 508 by the long-term storage server to produce an aggregated report 510 from the raw audit data 506, where the aggregated report 510 may include statistical information associated with the audit data. The aggregated report 510 may be converted into a format compatible with a compliance user interface 512, such as an audit reporting user interface, of the auditing application, which may be executed on the other client device associated with the administrator.

The examples in FIG. 1 through 5 have been described with specific platforms including datacenters, systems, servers, applications, processes, and interactions. Embodiments are not limited to systems according to these example configurations. Compliant auditing architecture for collecting and storing audit data may be implemented in configurations using other types of platforms including datacenters, systems, servers, applications, processes, and interactions in a similar manner using the principles described herein.

Audit of user activities for the purpose of compliance with industry laws and regulations is a top feature requested by customers who are working in regulated industries such as financial, legal, insurance, and/or health care. A compliant auditing architecture may be implemented such that a uniform experience of collecting, storing, and interacting with audit data may be provided for various compliance scenarios. Transmission of audit data to a data store for long-term storage may advantageously enhance reliability by enabling retention of audit data compliant with industry standards. Furthermore, conversion of the stored data to a format compatible with one or more compliance interfaces may advantageously improve usability for administrators that may interact with the data through the interfaces for querying and/or reporting.

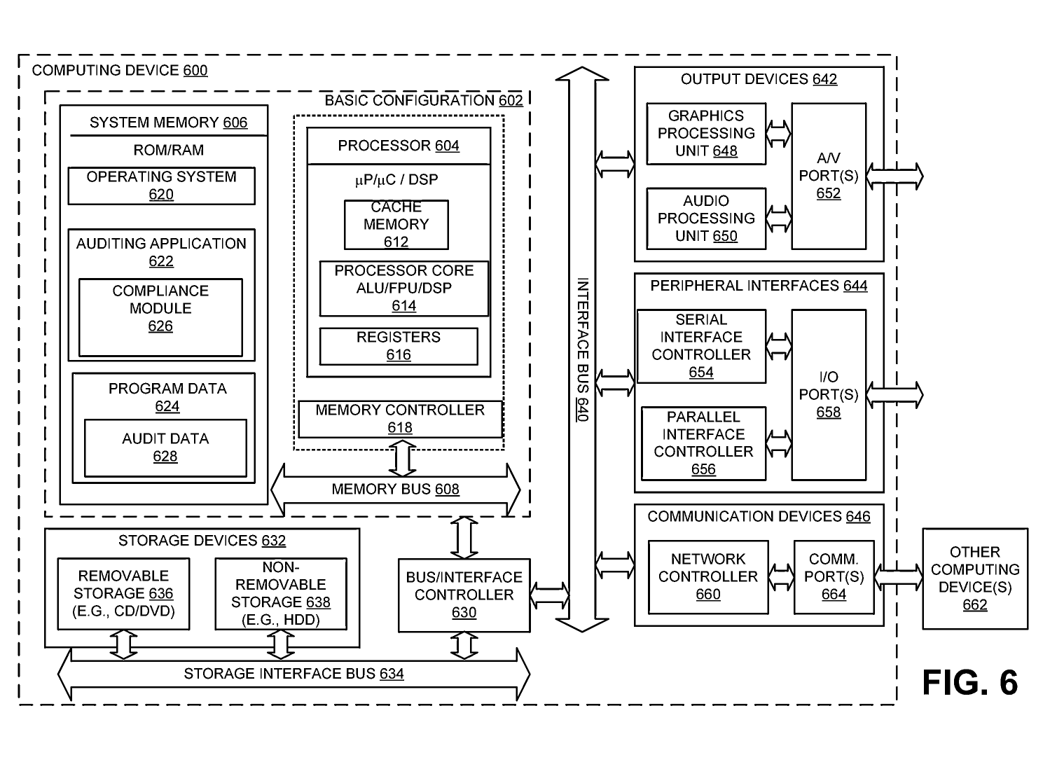

FIG. 6 and the associated discussion are intended to provide a brief, general description of a general purpose computing device, which may be used to collect and store audit data implementing a compliant auditing architecture, arranged in accordance with at least some embodiments described herein.

For example, computing device 600 may be used as a server, desktop computer, portable computer, smart phone, special purpose computer, or similar device. In an example basic configuration 602, the computing device 600 may include one or more processors 604 and a system memory 606. A memory bus 608 may be used for communicating between the processor 604 and the system memory 606. The basic configuration 602 is illustrated in FIG. 6 by those components within the inner dashed line.

Depending on the desired configuration, the processor 604 may be of any type, including but not limited to a microprocessor (μP), a microcontroller (μC), a digital signal processor (DSP), or any combination thereof. The processor 604 may include one more levels of caching, such as a level cache memory 612, one or more processor cores 614, and registers 616. The example processor cores 614 may (each) include an arithmetic logic unit (ALU), a floating point unit (FPU), a digital signal processing core (DSP Core), or any combination thereof. An example memory controller 618 may also be used with the processor 604, or in some implementations the memory controller 618 may be an internal part of the processor 604.

Depending on the desired configuration, the system memory 606 may be of any type including but not limited to volatile memory (such as RAM), non-volatile memory (such as ROM, flash memory, etc.) or any combination thereof. The system memory 606 may include an operating system 620, an auditing application 622, and program data 624. The auditing application 622 may include a compliance module 626, which may be an integral part of the application or a separate application on its own. The auditing application 622 may be configured to detect a user action through a user interface of an, application executed on a client device associated with a user, where the user action requires auditing. A protocol service of the auditing application 622 may be configured to generate an audit event corresponding to the user action, and transmit the audit data associated with the audit event to a local queue of a datacenter for short-term storage, where the audit data may be uploaded from the local queue through an upload service hosted by the datacenter for long-term storage at a data store. The compliance module 626 may be configured to enable an administrator, such as a compliance officer, to interact with the audit data stored in the data store through one or more corresponding compliance user interfaces of the auditing application 622 executed on another client device associated with the administrator. The interactions may include querying the audit data and/or reporting statistical information associated with the audit data, where the corresponding compliance user interfaces may include a querying user interface, and an audit reporting user interface, respectively. The program data 524 may include, among other data, audit data 628, as, described herein.

The computing device 600 may have additional features or functionality, and additional interfaces to facilitate communications between the basic configuration 602 and any desired devices and interfaces. For example, a bus/interface controller 630 may be used to facilitate communications between the basic configuration 602 and one or more data storage devices 632 via a storage interface bus 634. The data storage devices 632 may be one or more removable storage devices 636, one or more non-removable storage devices 638, or a combination thereof. Examples of the removable storage and the non-removable storage devices include magnetic disk devices such as flexible disk drives and hard-disk drives (HDDs), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 606, the removable storage devices 636 and the non-removable storage devices 638 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus 640 for facilitating communication from various interface devices (for example, one or more output devices 642, one or more peripheral interfaces 644, and one or more communication devices 646) to the basic configuration 602 via the bus/interface controller 630. Some of the example output devices 642 include a graphics processing unit 648 and an audio processing unit 650, which may be configured to communicate to various external devices such as a display or speakers via one or more A/V ports 652. One or more example peripheral interfaces 644 may include a serial interface controller 654 or a parallel interface controller 656, which may be configured to communicate with external devices such as input devices (for example, keyboard, mouse, pen, voice input device, touch input device, etc.) or other peripheral devices (for example, printer, scanner, etc.) via one or more I/O ports 658. An example communication device 646 includes a network controller 660, which may be arranged to facilitate communications with one or more other computing devices 662 over a network communication link via one or more communication ports 664. The one or more other computing devices 662 may include servers, client devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 600 may be implemented as a part of a general purpose or specialized server, mainframe, or similar computer that includes any of the above functions. The computing device 600 may also be implemented as a personal computer including both laptop computer and non-laptop computer configurations.

Example embodiments may also include methods to implement a compliant auditing architecture for collecting a storing audit data. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

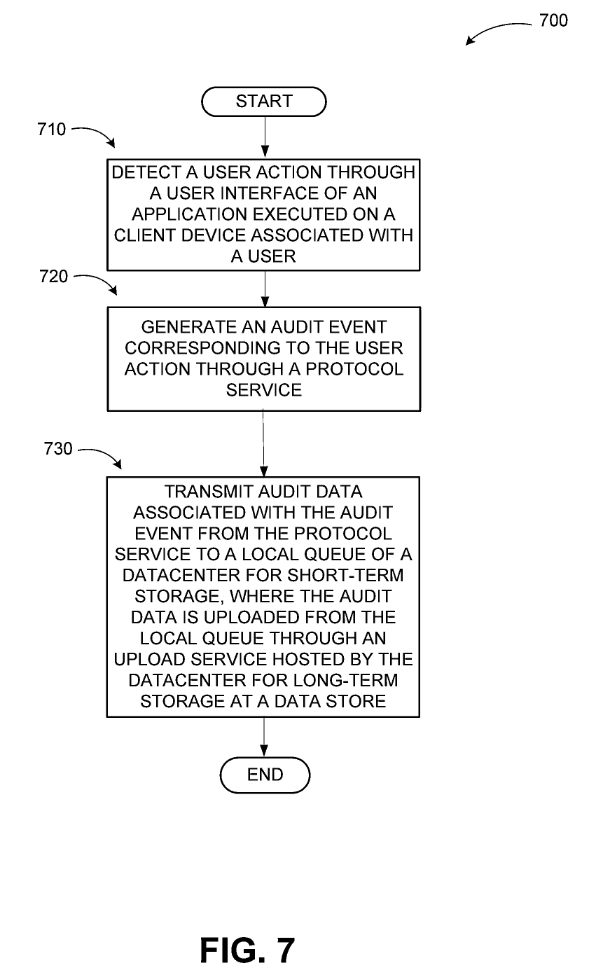

FIG. 7 illustrates a logic flow diagram for process 700 of a method to collect and store audit data implementing a compliant auditing architecture, according to embodiments. Process 700 may be implemented on a server or other system.

Process 700 begins with operation 710, where a user action may be detected through a user interface of an application executed on a client device. The user action may require auditing and accordingly at operation 720, a protocol service of the application may be configured to generate an audit event corresponding to the user action.

At operation 730, the protocol service may transmit audit data associated with the audit event to a local queue of a datacenter for short-term storage. In some embodiments, data associated with multiple audit events generated from a variety of protocol services may accumulate at the local queue. The audit data and/or accumulated audit data may then be uploaded through an upload service hosted by the datacenter for long-term storage at a data store.

The operations included in process 700 are for illustration purposes. Collection and storage of audit data through a compliant auditing architecture may be implemented by similar processes with fewer or additional steps, as well as in different order of operations using the principles described herein.

According to some embodiments, a method to collect and store audit data implementing a compliant auditing architecture may be provided. An example method may include a means for detecting a user action through a user interface of an application executed on a client device associated with a user, a means for generating an audit event corresponding to the user action though a protocol service, and a means for transmitting audit data associated with the audit event from the protocol service to a local queue of a datacenter for short-term storage, where the audit data is uploaded from the local queue through an upload service hosted by the datacenter for long-term storage at a data store.

According to some examples, methods to collect and store audit data implementing a compliant auditing architecture may be provided. An example method may include detecting a user action through a user interface of an application executed on a client device associated with a user, generating an audit event corresponding to the user action though a protocol service, and transmitting audit data associated with the audit event from the protocol service to a local queue of a datacenter for short-term storage, where the audit data is uploaded from the local queue through an upload service hosted by the datacenter for long-term storage at a data store.

In other examples, the stored audit data may be converted into a format compatible with one or more compliance user interfaces of the application executed on another client device associated with the administrator in response to a request from an administrator to retrieve the audit data from the data store. The audit data may be provided in the compatible format to the administrator for querying through a query user interface of the other client device. The audit data may be provided in the compatible format to the administrator for reporting of statistical information associated with the audit data through an audit reporting user interface of the other client device.

In further examples, audit data associated with multiple audit events generated by a variety of protocol services may be accumulated at the local queue. During the upload of the audit data, the audit data may be batched. The batched audit data may be transmitted to corresponding partitions of the data store for long-term storage. During the upload of the audit data, a consistency and a correctness of the audit data may be verified.

According to some embodiments, systems configured to implement a compliant auditing architecture may be described. An example system may include a communication module configured to transmit audit data between one or more servers of the system and one or more client devices associated with the system. The example system may also include at least one short-term storage server configured to receive audit data associated with an audit event at a local queue for short-term storage, where the audit data is received through the communication module from a protocol service through an application executed on a client device associated with a user, the protocol service generating the audit event to correspond to a user action detected through a user interface of the application, and accumulate further audit data associated with multiple audit events generated by a variety of protocol services at the local queue. The example system may further include at least one processing server coupled to the at least one short-term storage server through the communication module, where the processing server hosts an upload service, and is configured to upload the accumulated audit data from the local queue through the upload service, and batch the accumulated audit data such that the batched audit data is transmitted to corresponding partitions of a data store for long-term storage. The example system may further include at least one long-term storage server coupled to the processing server through the communication module, the long-term storage server configured to receive the batched audit data from the processing server, and store the batched audit data at the corresponding partitions of the data store.

In other embodiments, the upload of the audit data may be based on a specific workload of the protocol service. The audit data may be written into a persisted queue of the protocol service by an audit handler provided through a unified policy framework, and initially uploaded by the protocol service prior to being uploaded through the upload service if the workload of the protocol service is integrated with the unified policy framework. The audit data may be transmitted directly from the protocol service to the at least one processing server for uploading through the upload service if the workload of the protocol service is not integrated with a unified policy framework.

In further embodiments, the long-term storage of the audit data may be common to workloads of the variety of protocol services. The audit data may be stored in two tables within the data store, a first of the two tables including query-searchable properties of the audit data and a second of the two tables including overflow and multi-value properties of the audit data. The system may be implemented at a datacenter.

According to some examples, computer-readable memory devices with instructions stored thereon to collect and store audit data implementing a compliant auditing architecture may be described. Example instructions may include detecting a user action through a user interface of an application executed on a client device associated with a user, generating an audit event corresponding to the user action though a protocol service, and transmitting audit data associated with the audit event from the protocol service to a local queue for short-term storage. The example instructions may also include uploading the audit data through an uploader service for long-term storage at a data store, and providing the stored audit data to an administrator for one or more of querying and reporting statistical information associated with the audit data through one or more compliance user interfaces of another client device associated with the administrator.

In other embodiments, the audit data may be aggregated periodically to facilitate conversion of the stored audit data to a compatible format for the one or more compliance user interfaces in response to a request from the administrator to receive the stored audit data for the one or more of querying and reporting. The audit data may be aggregated in response to detecting duplicated audit data. The duplicated audit data may be detected in response to detecting a match of the user action, the user, and an object of two audit events, wherein the match of the user action, the user, and the object of two audit events may be detected at one or more of the protocol service of the application, the local queue, the upload service, and the data store.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to collect and store audit data implementing a compliant auditing architecture, the method comprising:
detecting a user action through a user interface of an application executed on a client device associated with a user;
generating an audit event corresponding to the user action though a protocol service; and
transmitting audit data associated with the audit event from the protocol service to a local queue of a datacenter for short-term storage, wherein the audit data is uploaded from the local queue through an upload service hosted by the datacenter for long-term storage at a data store.

2. The method of claim 1, further comprising:
in response to a request from an administrator to retrieve the audit data from the data store, converting the stored audit data into a format compatible with one or more compliance user interfaces of the application executed on another client device associated with the administrator.

3. The method of claim 2, further comprising:
providing the audit data in the compatible format to the administrator for querying through a query user interface of the other client device.

4. The method of claim 2, further comprising:
providing the audit data in the compatible format to the administrator for reporting of statistical information associated with the audit data through an audit reporting user interface of the other client device.

5. The method of claim 1, further comprising:
accumulating audit data associated with multiple audit events generated by a variety of protocol services at the local queue.

6. The method of claim 1, further comprising:
during the upload of the audit data, batching the audit data.

7. The method of claim 6, further comprising:
transmitting the batched audit data to corresponding partitions of the data store for long-term storage.

8. The method of claim 1, further comprising:
during the upload of the audit data, verifying a consistency and a correctness of the audit data.

9. A system configured to implement a compliant auditing architecture, the system comprising:
a communication module configured to transmit audit data between one or more servers of the system and one or more client devices associated with the system;
at least one short-term storage server configured to:
receive audit data associated with an audit event at a local queue for short-term storage, wherein the audit data is received through the communication module from a protocol service through an application executed on a client device associated with a user, the protocol service generating the audit event to correspond to a user action detected through a user interface of the application; and
accumulate further audit data associated with multiple audit events generated by a variety of protocol services at the local queue;
at least one processing server coupled to the at least one short-term storage server through the communication module, wherein the at least one processing server hosts an upload service, and is configured to:
upload the accumulated audit data from the local queue through the upload service; and
batch the accumulated audit data such that the batched audit data is transmitted to corresponding partitions of a data store for long-term storage; and
at least one long-term storage server coupled to the at least one processing server through the communication module, the at least one long-term storage server configured to:
receive the batched audit data from the at least one processing server; and
store the batched audit data at the corresponding partitions of the data store.

10. The system of claim 9, wherein the upload of the audit data is based on a specific workload of the protocol service.

11. The system of claim 10, wherein the audit data is written into a persisted queue of the protocol service by an audit handler provided through a unified policy framework, and initially uploaded by the protocol service prior to being uploaded through the upload service if the workload of the protocol service is integrated with the unified policy framework.

12. The system of claim 10, wherein the audit data is transmitted directly from the protocol service by a workload specific audit handler to the at least one processing server for uploading through the upload service if the workload of the protocol service is not integrated with a unified policy framework.

13. The system of claim 9, wherein the long-term storage of the audit data is common to workloads of the variety of protocol services.

14. The system of claim 9, wherein the audit data is stored in two tables within the data store, a first of the two tables comprising query-searchable properties of the audit data and a second of the two tables comprising overflow and multi-value properties of the audit data.

15. The system of claim 9, wherein the system is implemented at a datacenter.

16. A computer-readable memory device with instructions stored thereon to collect and store audit data implementing a compliant auditing architecture, the instructions comprising:
detecting a user action through a user interface of an application executed on a client device associated with a user;
generating an audit event corresponding to the user action though a protocol service;
transmitting audit data associated with the audit event from the protocol service to a local queue for short-term storage;
uploading the audit data through an uploader service for long-term storage at a data store; and
providing the stored audit data to an administrator for one or more of querying and reporting statistical information associated with the audit data through one or more compliance user interfaces of another client device associated with the administrator.

17. The computer-readable memory device of claim 16, wherein the instructions further comprise:
aggregating the audit data periodically to facilitate conversion of the stored audit data to a compatible format for the one or more compliance user interfaces in response to a request from the administrator to receive the stored audit data for the one or more of querying and reporting.

18. The computer-readable memory device of claim 16, wherein the instructions further comprise:
aggregating the audit data in response to detecting duplicated audit data.

19. The computer-readable memory device of claim 18, further comprising:
detecting the duplicated audit data in response to detecting a match of the user action, the user, and an object of two audit events.

20. The computer-readable memory device of claim 19, wherein the match of the user action, the user, and the object of two audit events are detected at one or more of the protocol service of the application, the local queue, the upload service, and the data store.
